(19) United States
(12) Patent Application Publication
(10) Pub. No.: US 2009/0119592 A1
(43) Pub. Date: May 7, 2009

(54) SYSTEM AND METHOD FOR PROVIDING USER-SELECTED TOPICAL VIDEO CONTENT

(76) Inventor: MICHAEL BOERNER, Boise, ID (US)

Correspondence Address: DYKAS, SHAVER & NIPPER, LLP, P.O. BOX 877, BOISE, ID, 83701-0877, US

(21) Appl. No.: 12/264,134

(22) Filed: Nov. 3, 2008

Related U.S. Application Data
(60) Provisional application No. 60/984,599, filed on Nov. 1, 2007.

(51) Int. Cl. G06F 3/048

(52) U.S. Cl. 715/716

(57) ABSTRACT

A downloadable program and/or widget for installation on a user's computer, for the display of topical medial content, such as videos, selected based upon the users desires.

### PRIORITY

This application claims the priority date of the provisional application entitled SYSTEM FOR PROVIDING USER-SELECTED TOPICAL VIDEO CONTENT filed by Michael Boerner on Nov. 1, 2007, with application Ser. No. 60/984,599, the disclosure of which is incorporated herein by reference.

### FIELD OF THE INVENTION

The present invention generally relates to the transmission and display of media content, and more particularly relates to a system for providing a video feed user with user-selected topical video content, updated regularly, on a user's desktop, homepage or other display device.

### BRIEF DESCRIPTION OF THE DRAWINGS

FIG. 1 is a flow chart of a method according to a preferred embodiment of the invention.

FIG. 2 is a block diagram of an exemplary computer system.

FIG. 3 is a block diagram of a system according to a preferred embodiment of the invention.

### SUMMARY OF THE INVENTION

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

The invention is a system and method of remotely providing media content, such as video and/or audio, to users.

In the preferred embodiment, this media content is displayed through use of a widget, panel, toolbar, software application, web application, etc. (hereinafter “widget”). While the preferred embodiment displays the media content on a user's computer video display or within the user's Internet browser, other display devices (e.g., cell phones, music players, Internet connected television sets, Internet ready devices, flat screen displays, media display devices, DVR (digital video recorder) devices) could likewise be used. Such display devices collectively referred to as the user's “computer.” The media content may be displayed at any number of locations (e.g., within the user's home, within an office, within public spaces, elevators, hotel lobbies). While the preferred embodiment of the present invention comprises a “video” player, the term “video” is intended to be read broadly, including but not limited to media content, digital content, animations, audio, video, still pictures, images, graphics, etc.

In the preferred embodiment, the user is able to select types and/or categories of topical content he/she wishes to be delivered to the widget. For instance, the user may be proved (either in the widget itself or otherwise) content buttons for allowing the user to quickly select desired content. In one example the buttons would be labeled with topics such as “marriage,” “parenting,” “nutrition,” “career,” “professional growth,” etc. Depending upon the embodiment, the user may be able to select a single topic or may even make multiple category selections.

In the preferred embodiment, upon making his/her selections, a video player then opens and displays a current video from the content provider on that topic. It is preferred that the video player be embedded in the widget for automatic updating (preferably via RSS feeds of the media content (e.g., video/audio streams)), preceded by a video pre-roll and followed by a video post-roll. Preferably, the video player is designed to expand when launched and be scalable in size. It is preferred that new media content (e.g., video, audio, graphics) be automatically updated (again perhaps through an RSS feed) on a regular basis, for instance nightly, so that users are able to have new content pushed to them automatically.

The user preferably having the option of selecting several categories of content for sequential display, along with the ability to watch multiple categories back to back to back, even choosing the order of the videos to view. In some embodiments, the present invention provides the user with multiple capabilities for customization, including but not limited to the ability to create play list of favorite videos, an auto-play feature based on user designated time with short (e.g., five) second audio intro/alert, the ability to personalize common names in a reminder feature with the user setting a timer to play short clip (e.g., five seconds long) of the content's author (or other individual) reminding the user to play the current (“today's”) clip, the ability to view a personal tip of the day, the ability to apply personal thoughts to a journal, and the ability to view a Quote-of-the-Day applying to the video category selected.

Temporal Features. Additionally, once the widget has been downloaded and installed on the user's computer, or the user has logged onto the content provider's website for viewing the content online, the user can subscribe to and receive content in video form on the topics the user has selected in a number of different manners. For instance, in one example, the user can choose to receive fresh video content 24/7, with a new short (e.g., two to three minute) video clip posted every twenty-four hours or at preset times throughout the day. In another example, the user has the ability to have the fresh video segment automatically play each day at a predetermined time, and have displayed on the desktop an auto reminder if the video segment does not play (e.g., 30-60-90 minutes). In another example, the user can use an appropriate button to order a short (e.g., five-second) video to be played on a regular interval (e.g., every 90 minutes) as a reminder, with the user setting a timer to play short (e.g., five-second) clip of author reminding user to play today's clip. In another example, the user can enter other data, including but not limited to the number and ages of their children, their marital status and years married, their fitness goals as well as other personal information in order to receive content that is specific to their lifestyle, age group and demographic. New options will be added and on a frequent basis to more closely target the user's need for information that is catered to their individual preferences.

Navigational Features. In other embodiments, the present invention allows the user to access discussion forums and speaker/author's sites via links embedded in the toolbar or displayed at the end of the video, and to insert links within the personal journal to an appropriate video clip.

User Communications. It is preferred that the widget give the user the ability to forward to others (or tag/bookmark) any video the user selects, add feedback/comments to the video, and rate videos, e.g., on a scale of 1 to 5.

Usage Information. It is preferred that the widget give the user the ability to track her/his own personal video usage (similar to an odometer showing consecutive days of viewing, or aggregate days or number of clips viewed), by the content provider, or selected others, and also allowing a vendor (e.g., an advertiser, the content provider) to have the ability to track (e.g., anonymously) the user's video usage and selections.

The widget can also give a logged-in user the ability to denote which videos on the content provider's site that the user has already viewed, historically or over a specified period (e.g., last 90 days). In such an embodiment, upon viewing by the user, each video could be tagged by the system as being “already viewed” by that user; a user-defined symbol, such as a triangle, denoting “already viewed” would then be displayed adjacent to that video's title each time the user views a listing of videos.

Corporate Applications. The widget could be utilized by a corporation to send media announcements and/or recommended videos to employees/vendors on their network. By incorporating security over a network and on individual computers through password protection, the widget can offer private corporate vertical selections applying to each company, so that the widget could be placed on each desktop in the company and executive management can send one particular video or a category of videos to an individual employee or an entire class of employees (e.g., company policies and general corporate communication), tracking whether or not the users viewed the videos and even asking for feedback, polling for opinions, etc.

Advertising. The widget can incorporate an integrated advertising function, through its pre-roll on each video as well as banner and/or tile advertising on the toolbar itself and on the content provider's web page and all linked pages.

The widget also possibly permitting the user to make comments, keep a journal/diary, or other features.

Marketing Concepts. The widget presents an innovative method to move users to view specific content. The content can be presented as part of the emerging life-long learning industry, providing daily training/mentoring by experts in specific fields, endorsed by PhD's and Nobel laureates, etc. A user viewing the three to five minute videos every day for three months could be said to be obtaining benefits equivalent to completing the coursework of a university-level class, as documented by interviews with users. The content provider can use the toolbar as the vehicle to administer an incentive contest for users, with a daily giveaway (e.g. a video iPod®) or a special recognition or prize for a user viewing the videos in a particular category twenty-five days in a one-month period. The toolbar gives content providers (and their advertisers) the capability to develop whole media campaigns to reach millions of people with well-produced video, as well as with major advantages to authors affiliated with the content provider.

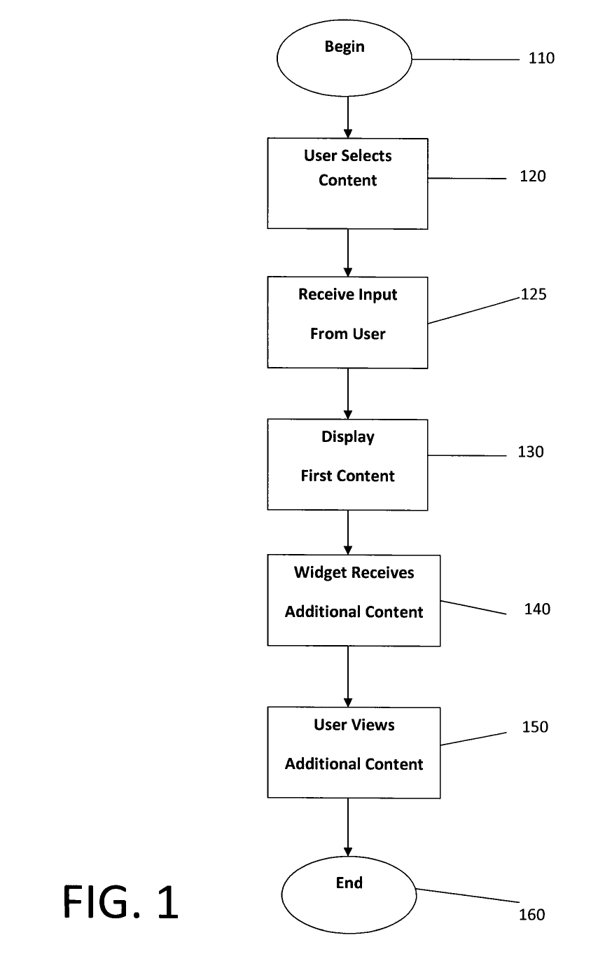

The flow chart of FIG. 1 illustrates a method according a preferred embodiment of the invention. The process begins at step 110. At step 120 a user selects desired content to be delivered to the widget. At step 125 this selection data is received either by a server computer or in some other way by a provider of such content. The user may use a client computer to interact with the server computer via a communications network such as the Internet or a Local Area Network (LAN). This may involve filling in a form on a web page and sending the form to the server via a hypertext protocol operation such as a ‘post’ or ‘get’ operation, or it may involve sending an electronic mail message, or may involve communicating by any other suitable protocol.

In step 130, the widget then displays a first content item from the content provider based upon the selected content. In step 140, the widget automatically receives additional content for display to the user at a later time. In step 150, the user selects when to view/listen to additional content items from the content provider. In step 160, the process ends.

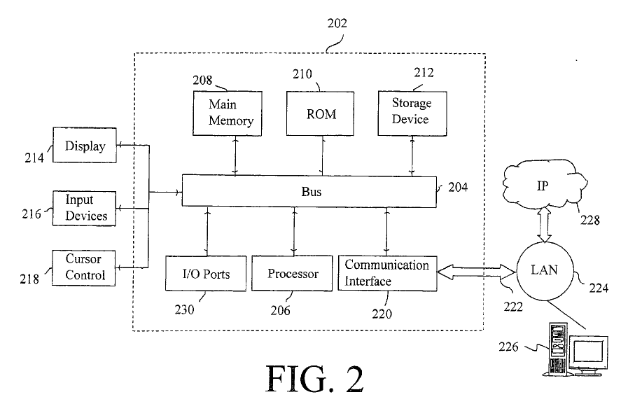

FIG. 2 illustrates a computer system 202 upon which the present invention may be implemented. The computer system 202 may be any one of a personal computer system, a work station computer system, a lap top computer system, an embedded controller system, a microprocessor-based system, a digital signal processor-based system, a hand held device system, a personal digital assistant (PDA) system, a wireless system, a wireless networking system, etc. The computer system 202 includes a bus 204 or other communication mechanism for communicating information and a processor 206 coupled with bus 204 for processing the information. The computer system 202 also includes a main memory 208, such as a random access memory (RAM) or other dynamic storage device (e.g., dynamic RAM (DRAM), static RAM (SRAM), synchronous DRAM (SDRAM), flash RAM), coupled to bus 204 for storing information and instructions to be executed by processor 206. In addition, main memory 208 may be used for storing temporary variables or other intermediate information during execution of instructions to be executed by processor 206. Computer system 202 further includes a read only memory (ROM) 210 or other static storage device (e.g., programmable ROM (PROM), erasable PROM (EPROM), and electrically erasable PROM (EEPROM)) coupled to bus 204 for storing static information and instructions for processor 206. A storage device 212, such as a magnetic disk or optical disk, is provided and coupled to bus 404 for storing information and instructions.

The computer system 202 also includes input/output ports 230 to couple the computer system 202 to external devices. Such coupling may include direct electrical connections, wireless connections, networked connections, etc., for implementing automatic control functions, remote control functions, etc.

The computer system 202 may also include special purpose logic devices (e.g., application specific integrated circuits (ASICs)) or configurable logic devices (e.g., generic array of logic (GAL) or re-programmable field programmable gate arrays (FPGAs)). Other removable media devices (e.g., a compact disc, a tape, and a removable magneto-optical media) or fixed, high-density media drives, may be added to the computer system 202 using an appropriate device bus (e.g., a small computer system interface (SCSI) bus, an enhanced integrated device electronics (IDE) bus, or an ultra-direct memory access (DMA) bus). The computer system 202 may additionally include a compact disc reader, a compact disc reader-writer unit, or a compact disc jukebox, each of which may be connected to the same device bus or another device bus.

The computer system 202 may be coupled via bus 204 to a display 214, such as a cathode ray tube (CRT), liquid crystal display (LCD), voice synthesis hardware and/or software, etc., for displaying and/or providing information to a computer user. The display 214 may be controlled by a display or graphics card. The computer system includes input devices, such as a keyboard 216 and a cursor control 218, for communicating information and command selections to processor 406. Such command selections can be implemented via voice recognition hardware and/or software functioning as the input devices 216. The cursor control 218, for example, is a mouse, a trackball, cursor direction keys, touch screen display, optical character recognition hardware and/or software, etc., for communicating direction information and command selections to processor 206 and for controlling cursor movement on the display 214. In addition, a printer may provide printed listings of the data structures, information, etc., or any other data stored and/or generated by the computer system 202.

The computer system 202 performs a portion or all of the processing steps of the invention in response to processor 206 executing one or more sequences of one or more instructions contained in a memory, such as the main memory 208. Such instructions may be read into the main memory 208 from another computer readable medium, such as storage device 212. One or more processors in a multi-processing arrangement may also be employed to execute the sequences of instructions contained in main memory 208. In alternative embodiments, hard-wired circuitry may be used in place of or in combination with software instructions. Thus, embodiments are not limited to any specific combination of hardware circuitry and software.

As stated above, the system 202 includes at least one computer readable medium or memory programmed according to the teachings of the invention and for containing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling the computer system 202, for driving a device or devices for implementing the invention, and for enabling the computer system 202 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 206 for execution. A computer readable medium may take many forms, including but not limited to, non-volatile media, volatile media, and transmission media. Non-volatile media includes, for example, optical, magnetic disks, and magneto-optical disks, such as storage device 212. Volatile media includes dynamic memory, such as main memory 208. Transmission media includes coaxial cables, copper wire and fiber optics, including the wires that comprise bus 204. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 206 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 202 may receive the data on the telephone line and use an infrared transmitter to convert the data to an infrared signal. An infrared detector coupled to bus 204 can receive the data carried in the infrared signal and place the data on bus 204. The bus 204 carries the data to main memory 208, from which processor 206 retrieves and executes the instructions. The instructions received by main memory 208 may optionally be stored on storage device 212 either before or after execution by processor 206.

The computer system 202 also includes a communication interface 220 coupled to bus 204. Communication interface 220 provides a two-way data communication coupling to a network link 222 that may be connected to, for example, a local network 224. For example, communication interface 220 may be a network interface card to attach to any packet switched local area network (LAN). As another example, communication interface 220 may be an asymmetrical digital subscriber line (ADSL) card, an integrated services digital network (ISDN) card or a modem to provide a data communication connection to a corresponding type of telephone line. Wireless links may also be implemented via the communication interface 220. In any such implementation, communication interface 220 sends and receives electrical, electromagnetic or optical signals that carry digital data streams representing various types of information.

Network link 222 typically provides data communication through one or more networks to other data devices. For example, network link 222 may provide a connection to a computer 226 through local network 224 (e.g., a LAN) or through equipment operated by a service provider, which provides communication services through a communications network 228. In preferred embodiments, local network 224 and communications network 228 preferably use electrical, electromagnetic, or optical signals that carry digital data streams. The signals through the various networks and the signals on network link 222 and through communication interface 220, which carry the digital data to and from computer system 202, are exemplary forms of carrier waves transporting the information. The computer system 202 can transmit notifications and receive data, including program code, through the network(s), network link 222 and communication interface 220.

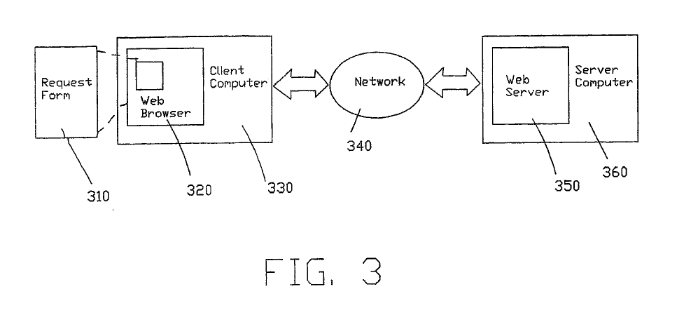

FIG. 3 shows a block diagram of a system according to a preferred embodiment of the invention, including a client computer and a server computer. FIG. 3 shows a client computer 330 connected to a server computer 360 via a network 340, which could for example be the Internet or a LAN. Each of the client computer 330 and the server computer 360 may incorporate the elements of the computer systems as described in relation to FIG. 2. The user enters a request for video content into a request form 310 in a web browser 320, and the request is communicated via the net work 340 to a web server program 350 running on a the server computer 360. The protocols that may be used have been discussed previously. The method as shown in FIG. 1 may then take place either as a series of steps in a stored program run on the server computer or on another computer, and any or all portions of this method may instead be performed manually by the content provider.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawing and description of the preferred embodiments are to be regarded as illustrative in nature, and not as restrictive in nature. While there is shown and described the present preferred embodiment of the invention, it is to be distinctly understood that this invention is not limited thereto, but may be variously embodied to practice within the scope of this disclosure. From the foregoing description, it will be apparent that various changes may be made without departing from the spirit and scope of the invention.

I claim:

1. A method for providing user-selected topical video content, said method comprising the steps of: installing an audio/video player on a user's computer; asking a user for input regarding desired content; receiving said input from a user; selecting content playlist from a digital library based upon said input; transmitting to said audio/video player a first content item for display from said content playlist; and transmitting said future content items for display to said audio/video player.
